(19) United States
(12) Patent Application Publication
(10) Pub. No.: US 2020/0028426 A1
(43) Pub. Date: Jan. 23, 2020

(54) ELECTRONIC DEVICE

(71) Applicant: ALPS ALPINE CO., LTD., Tokyo (JP)

(72) Inventor: Tomokuni WAUKE, Miyagi (JP)

(21) Appl. No.: 16/587,317

(22) Filed: Sep. 30, 2019

Related U.S. Application Data
(63) Continuation of application No. PCT/JP2018/011413, filed on Mar. 22, 2018.

(30) Foreign Application Priority Data
Apr. 3, 2017 (JP) 2017-073547

(51) Int. Cl. H02K 33/06; G06F 3/01; G06F 3/041

(52) U.S. Cl. CPC H02K 33/06; G06F 3/041; G06F 3/016

(57) ABSTRACT

An electronic device includes an input element configured to input information, the input element being responsive to a touch on a surface of the input element, a casing having an opening in which the input element is disposed, at least one elastic connecting section connected to the input element and the casing and configured to support the input element, and at least one vibration generating device attached to the input element or the elastic connecting section, the vibration generating device being configured to vibrate in two directions perpendicular to each other. The elastic connecting section is configured to be deformed in the two directions.

### CROSS-REFERENCE TO RELATED APPLICATION

This application is a continuation application of International Application No. PCT/JP2018/011413, filed Mar. 22, 2018, and designated the U.S., which is based upon and claims priority to Japanese Patent Application No. 2017-073547, filed Apr. 3, 2017, the entire contents of which are incorporated herein by reference.

### BACKGROUND OF THE INVENTION

### 1. Field of the Invention

The present disclosure relates to an electronic device.

### 2. Description of the Related Art

Touch panels are used as electronic devices for inputting information, responsive to touching a panel surface with a finger or the like. Some touch panels have a built-in module for generating vibrations (hereinafter referred to as a vibration generating module) to give an indication to a finger or the like that touches a surface of the touch panel. When a vibration generating module vibrates, a surface of a touch panel is vibrated accordingly. In such a manner, an indication is given to a finger that touches the surface of the touch panel, through the tactile feeling. See, Japanese Unexamined Patent Application Publication Nos. 2011-60261 and 2013-161384.

### SUMMARY OF THE INVENTION

In one aspect of one or more embodiments, an electronic device includes an input element configured to input information, the input element being responsive to a touch on a surface of the input element, a casing having an opening in which the input element is disposed, at least one elastic connecting section connected to the input element and the casing and configured to support the input element, and at least one vibration generating device attached to the input element or the elastic connecting section, the vibration generating device being configured to vibrate in two directions perpendicular to each other. The elastic connecting section is configured to be deformed in the two directions.

### BRIEF DESCRIPTION OF THE DRAWINGS

FIG. 1 is a perspective view of an example of a vibration generating device according to one or more embodiments;

FIG. 2 is an exploded perspective view of an example of the vibration generating device according to one or more embodiments;

FIG. 3 is a perspective view of an example of a vibrator according to one or more embodiments;

FIG. 4 is a perspective view of an example of an elastic support section according to one or more embodiments;

FIG. 5 is a front view of an example of the elastic support section according to one or more embodiments;

FIG. 6 is a perspective view of an example of an elastic support section to which the vibrator is attached, according to one or more embodiments;

FIG. 7 is a front view of an example of the elastic support section to which the vibrator is attached, according to one or more embodiments;

FIG. 8 is a perspective view of an example of an internal state of the vibration generating device according to one or more embodiments;

FIG. 9 is a diagram for explaining an example of a permanent magnet according to one or more embodiments;

FIG. 10A is a diagram (1) for explaining an example of a vibration generating device according to one or more embodiments;

FIG. 10B is a diagram (2) for explaining an example of a vibration generating device according to one or more embodiments;

FIG. 11A is a diagram (3) for explaining an example of a vibration generating device according to one or more embodiments;

FIG. 11B is a diagram (4) for explaining an example of a vibration generating device according to one or more embodiments;

FIG. 12 is a perspective view of an example of an electronic device according to a first embodiment;

FIG. 13 is an exploded perspective view of an example of the electronic device according to the first embodiment;

FIG. 14 is a perspective view of an example of a first spring section and a second spring section according to the first embodiment;

FIG. 15 is a side view of an example of the first spring section and the second spring section according to the first embodiment;

FIG. 16 is a diagram (1) for explaining an example of the electronic device according to the first embodiment;

FIG. 17 is a diagram (2) for explaining an example of the electronic device according to the first embodiment;

FIG. 18 is a diagram (3) for explaining an example of the electronic device according to the first embodiment;

FIG. 19 is a diagram (4) for explaining an example of the electronic device according to the first embodiment;

FIG. 20 is a diagram (5) for explaining an example of the electronic device according to the first embodiment;

FIG. 21 is a diagram (1) for explaining an example of the electronic device according to a second embodiment; and

FIG. 22 is a diagram (2) for explaining an example of the electronic device according to the second embodiment.

### DESCRIPTION OF THE PREFERRED EMBODIMENTS

With respect to an electronic device in which a touch panel is touched through a finger or the like, the inventor has recognized that the electronic device is required to generate vibrations in different vibrational directions from which respective types of tactile feeling come, in order to give different indications to the finger or the like that touches the touch panel.

Embodiments will be described hereinafter with reference to the drawings. Note that same reference numerals are used to denote same components or the like in each drawing; accordingly, for the same components or the like, explanation may be omitted. In the following description, an X1-X2 direction, a Y1-Y2 direction and a Z1-Z2 direction are mutually perpendicular. A plane including the X1-X2 direction and the Y1-Y2 direction refers to an XY plane, a plane including the Y1-Y2 direction and the Z1-Z2 direction refers to a YZ plane, and a plane including the Z1-Z2 direction and the X1-X2 direction refers to a ZX plane.

### First Embodiment

### (Vibration Generating Module)

Hereafter, a vibration generating device that is a vibration generating module mounted on an electronic device according to a first embodiment will be described.

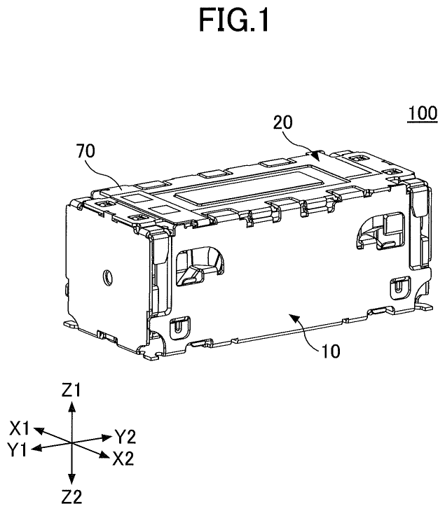

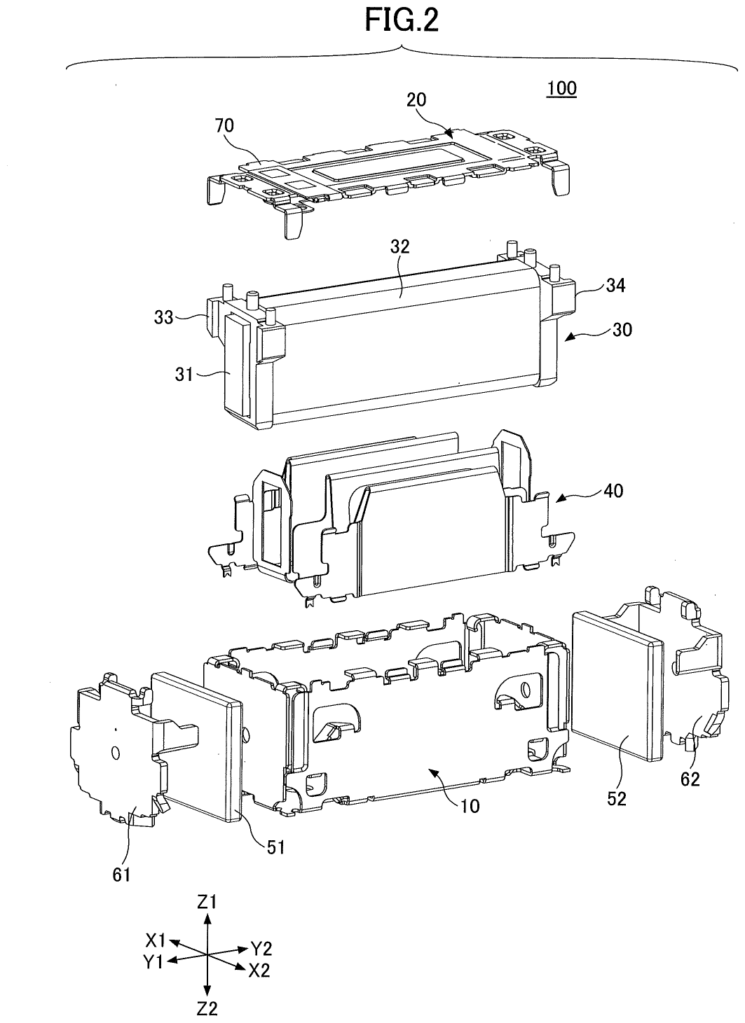

As illustrated in FIGS. 1 and 2, a vibration generating device 100 according to the present embodiment includes a housing body 10, a cover 20, a vibrator 30, an elastic support section, permanent magnets 51 and 52, and yokes 61 and 62, and the like. In the present embodiment, a housing of the vibration generating device includes the housing body 10 and the cover 20.

The housing body 10 is formed by processing a metal plate, and has an approximately cuboid box shape. The housing body 10 has a base and four sides that enclose the base. A component that constitutes part of the vibration generating device is disposed in an opening of the housing body. The housing body 10 has an approximately rectangular shape in which a Y1-Y2 direction is a longitudinal direction of the housing body 10 and an X1-X2 direction is a short direction thereof. The four sides are two opposite longitudinal sides and two opposite short sides. The respective longitudinal sides are formed on opposite sides along a longitudinal direction of the base, e.g., the Y1-Y2 direction. The respective short sides are formed on opposite sides along a short direction of the base, e.g., the X1-X2 direction.

The cover 20 is formed by processing a metal plate, and is a plate member that has an approximately rectangular shape. The cover 20 is formed so as to cover an opening of the housing body 10.

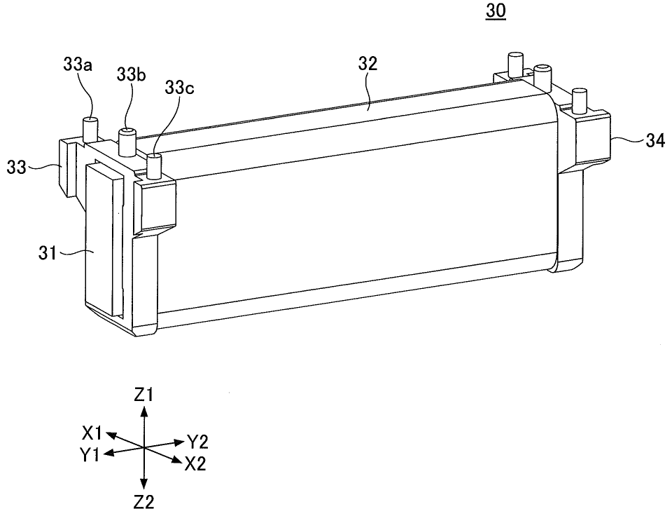

As illustrated in FIG. 3, the vibrator 30 is an electromagnet. The vibrator 30 includes a core 31, a coil 32, flanges 33 and 34, and the like. The coil 32 is formed by winding an electric wire around the core 31. The core 31 is formed of a ferromagnetic material such as iron, and has a prismatic shape. The coil 32 is formed by winding an electric wire at approximately right angles with respect to a longitudinal direction of the core 31 that is a Y1-Y2 direction. The respective flanges 33 and 34 are mounted in surroundings of respective ends of the core 31 along a longitudinal direction of the core 31. Three protrusions 33a, 33b, and 33c are provided on an upper face side of the flange 33, i.e., toward a Z1 direction. Each of the protrusions 33a and 33c is used as a terminal. Both ends of an electric wire that constitutes the coil 32 are respectively wound around the protrusions 33a and 33c, which is not illustrated in the drawings.

As described above, the protrusions 33a and 33c around which the electric wire is wound are connected to an electrode terminal on one side of an FPC (Flexible Printed Circuit) 70, which is not illustrated. Another side of the FPC 70 is connected to an external circuit that is not illustrated, and a current is supplied to the coil 32 from the external circuit that is not illustrated, via the FPC 70.

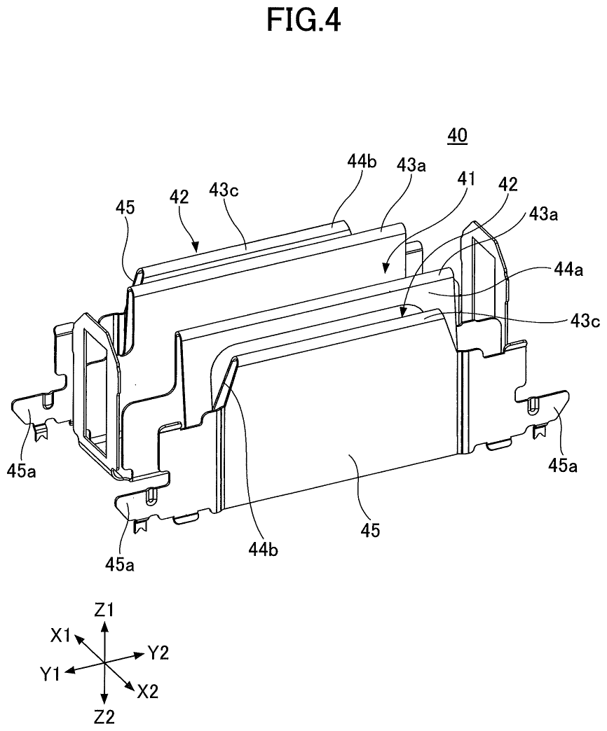

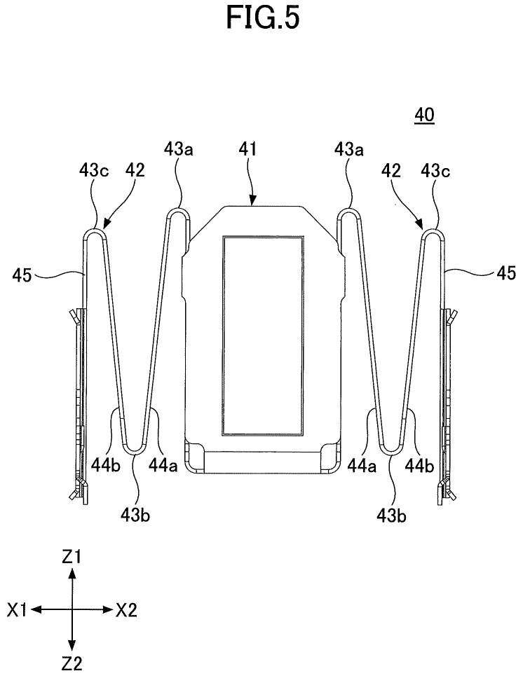

As illustrated in FIGS. 4 and 5, the elastic support section 40 is formed by processing a springy metal plate in a predetermined shape. The elastic support section 40 includes a holding section 41 into which the vibrator 30 is inserted, and includes spring sections 42 on both respective sides of the holding section 41. FIG. 4 is a perspective view of the elastic support section 40. FIG. 5 is a front view of the elastic support section 40.

Each of the spring sections 42 is a leaf spring. Each spring section 42 is formed by bending a metal plate along a Y1-Y2 direction many times, the metal plate extending in an X1-X2 direction. One of the two spring sections 42 is formed toward an X1 direction with respect to the holding section 41. Another spring section 42 is formed toward an X2 direction with respect to the holding section 41.

Specifically, as illustrated in FIG. 5, each spring section 42 includes three bent sections 43a, 43b, and 43c, two flat sections 44a and 44b, and a connecting section 45. Each of the bent sections 43a, 43b and 43c is a part that is bent along a Y1-Y2 direction, and the flat section 44a is formed between the bent section 43a and the bent section 43b. The flat section 44b is formed between the bent section 43b and the bent section 43c. Each of the flat sections 44a and 44b is formed so as to have an approximately rectangular shape, when viewed from an X1 direction side or an X2 direction side.

A leaf spring having a bent structure such as the elastic support section 40 illustrated in FIGS. 4 and 5, has the following characteristics: the leaf spring is easily deformed in directions that are perpendicular to a bending line marking where the leaf spring is bent, in other words, in an X1-X2 direction and a Z1-Z2 direction. On the other hand, the leaf spring is not easily deformed in a direction along the bending line of the leaf spring, e.g., in a Y1-Y2 direction. In one or more embodiments, the elastic support section 40 is elastically deformed in the X1-X2 direction by expansion and contraction, and is elastically deformed in the Z1-Z2 direction by deflection. On the other hand, the elastic support section 40 is not easily deformed in the X1-X2 direction.

In general, with respect to a leaf spring having a bent structure such as the elastic support section 40, an elastic deformation in a Z1-Z2 direction due to deflection is different from that in an X1-X2 direction due to expansion and contraction, in terms of ease of deformation. When an elastic coefficient in an X1-X2 direction with respect to the elastic support section 40 is set as a first elastic coefficient and an elastic coefficient in a Z1-Z2 direction with respect to the elastic support section 40 is set as a second elastic coefficient, the first elastic coefficient is different from the second elastic coefficient.

A given connecting section 45 is formed at one end of one spring section 42 toward an X1 direction with respect to the elastic support section 40. Also, a given connecting section 45 is formed at one end of another spring section 42 toward an X2 direction with respect to the elastic support section 40. In such a manner, each bent section 43c is between a given flat section 44b and a given connecting section 45. Connecting pawl sections 45a are provided at both respective ends of a given connecting section 45 along a longitudinal direction of the elastic support section 40, e.g., at connecting section ends toward a Y1 direction and a Y2 direction. Each connecting pawl section 45a is connected at an inner side of a short side of the housing body 10. In such a manner, the elastic support section 40 can be attached on the inside of the housing body 10. In the present embodiment, the elastic support section 40 is connected to the housing body 10 in a state such that the elastic support section 40 can be elastically deformed in an X1-X2 direction and a Z1-Z2 direction with respect to the housing body 10.

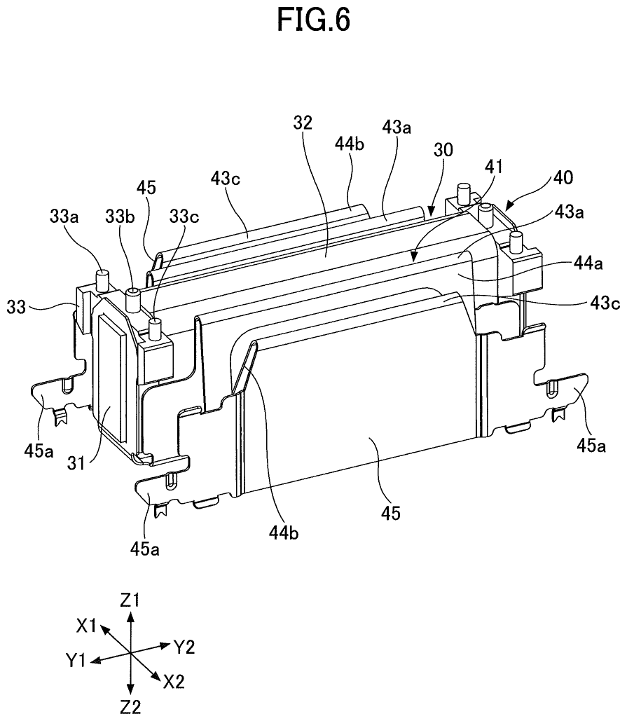

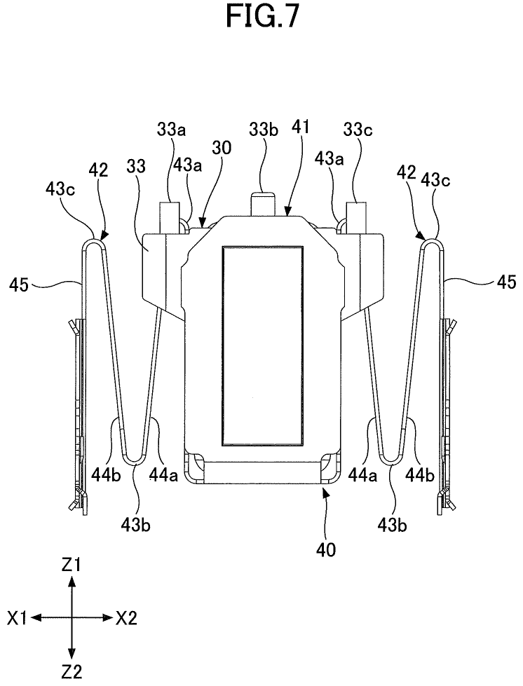

As illustrated in FIGS. 6 and 7, the vibrator 30 is retained in the holding section 41 in the elastic support section 40. As described above, the vibrator 30 that is placed in the holding section 41 of the elastic support section 40 vibrates in an X1-X2 direction according to a first natural frequency, which is determined by a first elastic coefficient and mass of the vibrator 30. Further, the vibrator 30 vibrates in a Z1-Z2 direction according to a second natural frequency, which is determined by a second elastic coefficient and mass of the vibrator 30. The first elastic coefficient is different from the second elastic coefficient, and thus the first natural frequency is also different from the second natural frequency.

When a current flows to the vibrator 30 formed of an electromagnet, a magnetic field is formed so that magnetic flux is formed along a Y1-Y2 direction. In such a manner, the vibrator 30 is magnetized to have different polarities on both sides along a longitudinal direction of the core 31. In this example, a polarity created by magnetization in the core 31 toward a Y1 direction is different from that in the core 31 toward a Y2 direction. For this reason, when an alternating current is supplied to the coil 32, the resulting magnetic field is an alternating magnetic field in which a direction of the magnetic field changes depending on a current flow. Thereby, a first state and a second state are alternately repeated, the first state being a state in which an S pole is created in the core 31 toward a Y1 direction and an N pole is created in the core 31 toward a Y2 direction, and the second state being a state in which an N pole is created in the core 31 toward a Y1 direction and an S pole is created in the core 31 toward a Y2 direction. Timing of forming an alternating magnetic field in the vibrator 30, as well as a frequency of an alternating magnetic field, are controlled by an external circuit, which is not illustrated, connected to the coil 32.

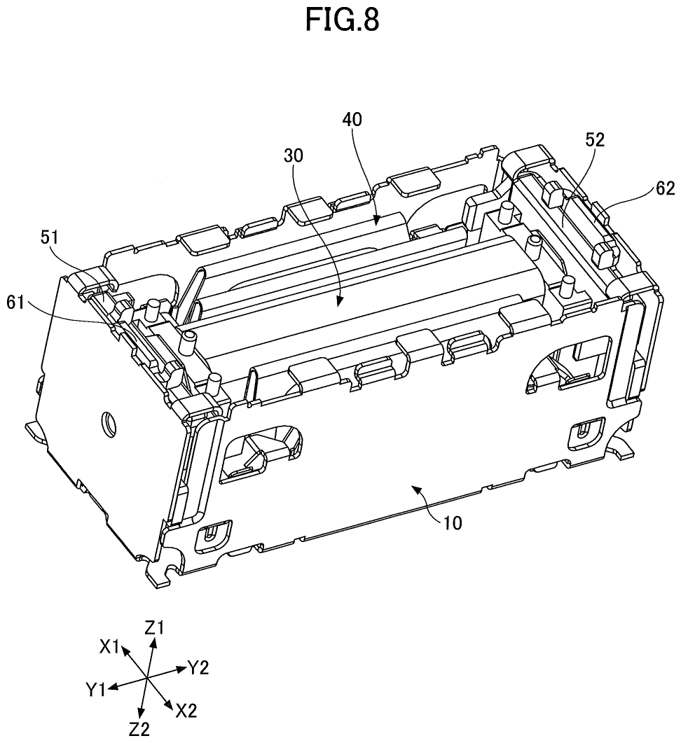

Each of the permanent magnets 51 and 52 is formed in an approximately square plate shape. As illustrated in FIG. 8, in the housing body 10, the permanent magnets 51 and 52 are disposed on both sides of the vibrator 30 in the longitudinal direction of the vibrator 30, e.g., on an extended line in a Y1-Y2 direction of the vibrator 30. Specifically, in the housing body 10, the permanent magnets 51 and 52 are each disposed on the extended line in the Y1-Y2 direction from the core 31 of the vibrator 30; as an example, the permanent magnet 51 is disposed toward a Y1 direction from the core 31 in the vibrator 30, and the permanent magnet 52 is disposed toward a Y2 direction from the core 31. Each of the permanent magnets 51 and 52 has a magnetized face among the widest approximate square faces. The magnetized face of the permanent magnet 51 faces an end face of the core 31 that is toward a Y1 direction in the vibrator 30. The magnetized face of the permanent magnet 52 faces an end face of the core 31 that is toward a Y2 direction in the vibrator 30. FIG. 8 is a perspective view of the vibration generating device according to the present embodiment from which the cover 20 and the FPC 70 are removed. In FIG. 8, the inside of the vibration generating device is illustrated.

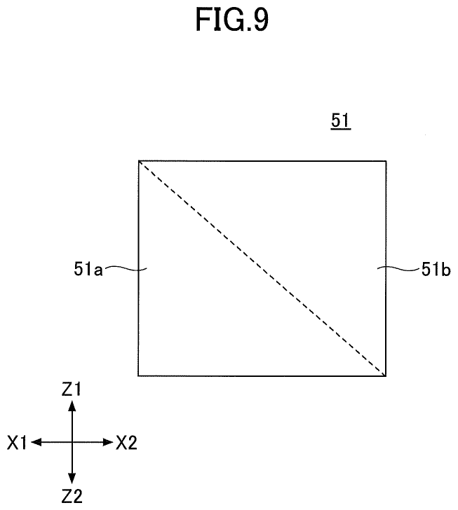

As illustrated in FIG. 9, each of the permanent magnets 51 and 52 has two regions that are separated by a diagonal line indicated by a dashed line, which is drawn from a left upper corner to a right lower corner of the magnet. The regions are configured such that different polarities are created by magnetization.

In the following description, a region on a left lower side of the permanent magnet 51, which is a region toward an X1 direction and a Z2 direction, is defined as a first magnetized region 51a. A region on a right upper side of the permanent magnet 51, which is a region toward an X2 direction and a Z1 direction, is defined as a second magnetized region 51b. The permanent magnet 51 is configured such that an S pole is created in the first magnetized region 51a and an N pole is created in the second magnetized region 51b, by magnetization. Similarly, the permanent magnet 52 has polarities, which are opposite to those of the permanent magnet 51. In other words, the permanent magnet 52 has a first magnetized region and a second magnetized region, where an N pole is created in the first magnetized region and an S pole is created in the second magnetized region, by magnetization.

In the housing body 10, a yoke 61 formed of a ferromagnetic material such as iron is disposed on a Y1 direction side outside the permanent magnet 51, in order to direct magnetic flux formed by the permanent magnet 51, toward the vibrator 30. A yoke 62 formed of a ferromagnetic material such as iron is disposed on a Y2 direction side outside the permanent magnet 52, in order to direct magnetic flux formed by the permanent magnet 52, toward the vibrator 30.

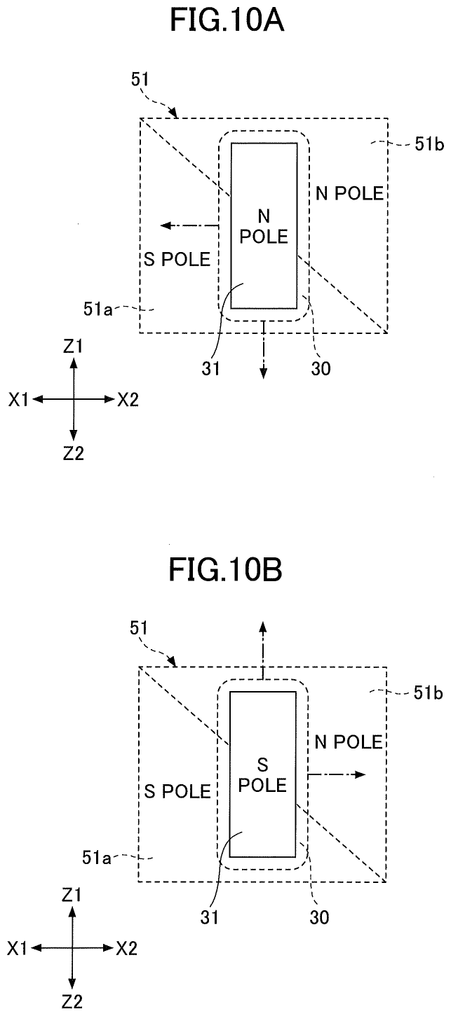

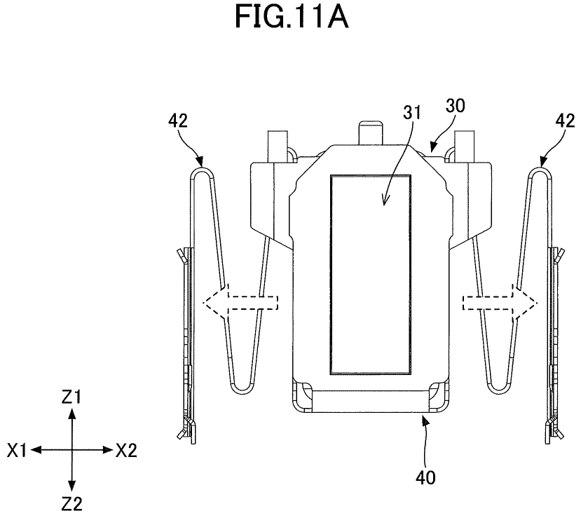

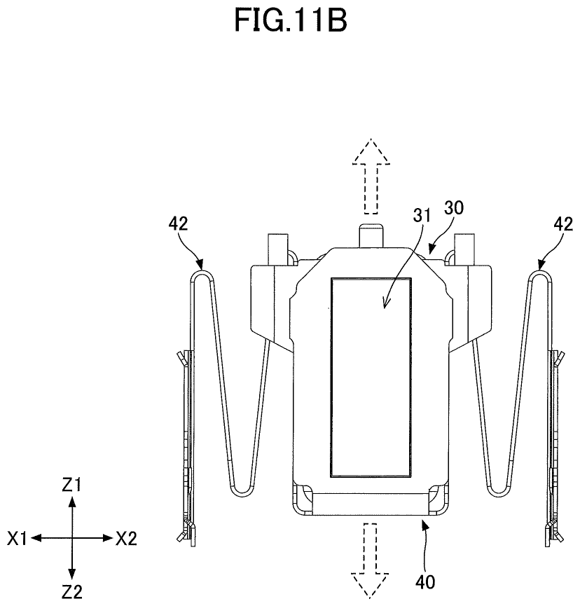

Hereafter, an operation of the vibration generating device according to the present embodiment will be described with reference to FIGS. 10A and 10B and 11A and 11B. With respect to the vibration generating device according to the present embodiment, alternating magnetic fields are formed by passing an alternating current through the coil 32 of the vibrator 30 formed of an electromagnet. Thereby, both ends of the core 31 toward respective opposite directions in a longitudinal direction of the core 31, which is a Y1-Y2 direction, are magnetized so as to have different polarities. The permanent magnet 51 and the permanent magnet 52 are disposed to face each other via the vibrator 30. The first magnetized region 51a of the permanent magnet 51 is situated opposite to a first magnetized region of the permanent magnet 52. The second magnetized region 51b of the permanent magnet 51 is situated opposite to a second magnetized region of the permanent magnet 52. In such a manner, the first magnetized region 51a of the permanent magnet 51 and the first magnetized region of the permanent magnet 52, which are opposite to each other, have different polarities created for magnetization. Also, the second magnetized region 51b of the permanent magnet 51 and the second magnetized region of the permanent magnet 52, which are opposite to each other, have different polarities created for magnetization.

In the present embodiment, as illustrated in FIG. 10A, when an end face of the core 31 toward a Y1 direction in the vibrator 30 is magnetized as an N pole, with respect to the end face of the core 31 toward the Y1 direction, attractive force of being attracted to the first magnetized region 51a of the permanent magnet 51, as well as repulsive force of repelling from the second magnetized region 51b of the permanent magnet 51, are applied. In this case, although not illustrated, an end face of the core 31 toward a Y2 direction in the vibrator 30 is magnetized as an S pole. Thus, with respect to the end face of the core 31 toward the Y2 direction, attractive force of being attracted to a first magnetized region of the permanent magnet 52, as well as repulsive force of repelling from a second magnetized region of the permanent magnet 52, are applied. Thereby, the vibrator 30 moves toward an X1 direction and a Z2 direction, as indicated by dashed arrows.

Alternatively, as illustrated in FIG. 10B, when an end face of the core 31 toward a Y1 direction in the vibrator 30 is magnetized as an S pole, with respect to the end face of the core 31 toward the Y1 direction, repulsive force of repelling from the first magnetized region 51a of the permanent magnet 51, as well as attractive force of being attracted to the second magnetized region 51b of the permanent magnet 51, are applied. In this case, although not illustrated, an end face of the core 31 toward a Y2 direction in the vibrator 30 is magnetized as an N pole. Thus, with respect to the end face of the core 31 toward the Y2 direction, repulsive force of repelling from a first magnetized region of the permanent magnet 51, as well as attractive force of being attracted to a second magnetized region of the permanent magnet 51, are applied. Thereby, the vibrator 30 moves toward an X2 direction and a Z1 direction, as indicated by dashed arrows.

In such a manner, with respect to the vibration generating device according to the present embodiment, an alternating magnetic field is formed by passing an alternating current through the coil 32 of the vibrator 30 that is formed of an electromagnet. In response to the formed alternating magnetic field, both of an attractive force and repulsive force act between the vibrator 30 and a given permanent magnet. Thereby, a first manner of the vibrator 30 moving toward an X1 direction or a Z2 direction, as well as a second manner of the vibrator 30 moving toward an X2 direction or a Z1 direction, are repeatedly achieved. Accordingly, vibrations are generated by the vibrator 30.

As described above, the vibrator 30 is supported by the elastic support section 40. The vibrator 30 vibrates along an X1-X2 direction according to a first natural frequency, which is determined by a first elastic coefficient and mass of the vibrator 30. Further, the vibrator 30 vibrates along a Z1-Z2 direction according to a second natural frequency, which is determined by a second elastic coefficient and mass of the vibrator 30.

When an alternating magnetic field having a same frequency as a first natural frequency is formed in the vibrator 30 formed of an electromagnet, the vibrator 30 can easily move in an X1-X2 direction, as illustrated in FIG. 11A. In such a manner, the vibrator 30 vibrates along the X1-X2 direction. Also, when an alternating magnetic field having a same frequency as a second natural frequency is formed in the vibrator 30 that is formed of an electromagnet, the vibrator 30 can easily move in a Z1-Z2 direction, as illustrated in FIG. 11B. In such a manner, the vibrator 30 vibrates along the Z1-Z2 direction. In the present embodiment, a same frequency as each of a first natural frequency and a second natural frequency allows the vibrator 30 to vibrate with large amplification of displacement, as well as ability to vibrate at a frequency close to each of the first natural frequency and the second natural frequency. Thus, it is possible to generate vibrations at a wide range of frequencies, compared to a case of vibrating at only one natural frequency.

As described above, with respect to the vibration generating device according to the present embodiment, in response to changing a frequency of an alternating current flowing in the coil 32 of the vibrator 30, a vibration in an X1-X2 direction and a vibration in a Z1-Z2 direction can be switched. Note that a current flowing to the coil 32 may be taken as a pulse wave having a predetermined frequency, instead of an alternating current. Even in this case, vibrations in an X1-X2 direction and a Z1-Z2 direction can be generated when a first manner and a second manner are repeatedly achieved, the first manner being a manner of attractive force and repulsive force acting in a given direction when the vibration generating device is energized, and the second manner being a manner of restoring the vibrator by elastic force applied by the elastic support section 40 when the vibration generating device is not energized.

(Electronic Device)

Hereafter, an electronic device according to the first embodiment will be described. In the present embodiment, the electronic device transmits a vibration to a finger or the like in a manner such that the finger or the like touches a portion of the electronic device. Explanation will be provided below for a touch panel as the electronic device according to the present embodiment.

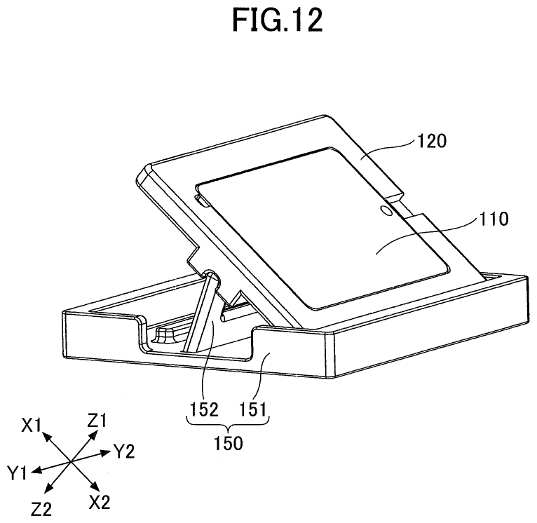

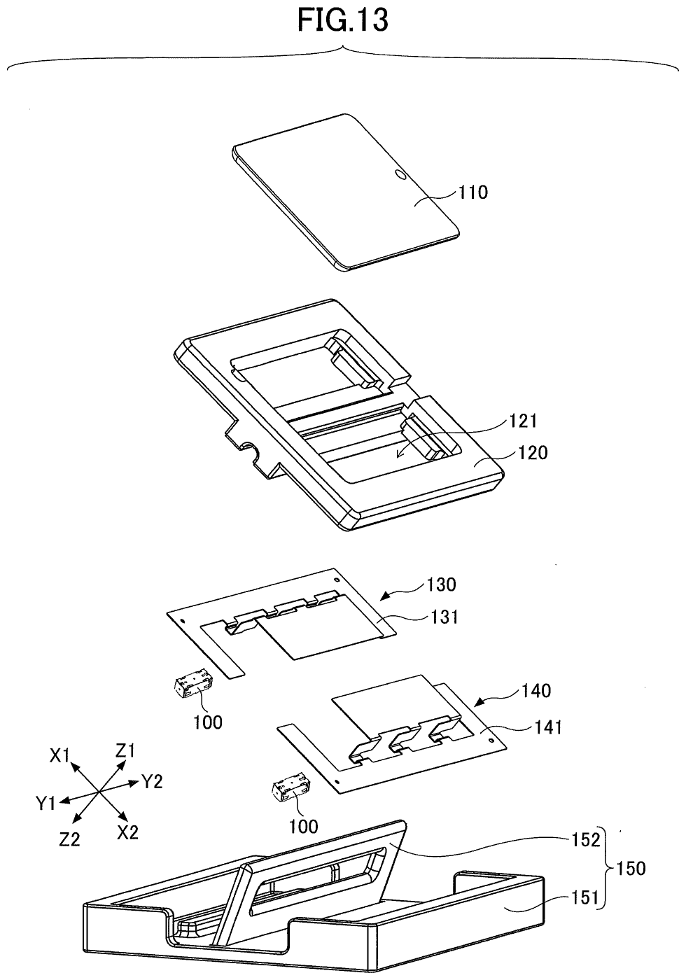

As illustrated in FIGS. 12 and 13, the electronic device according to the present embodiment includes a panel module 110, a casing 120, a first spring section 130, a second spring section 140, a support base 150, vibration generating devices 100, and the like. In the following description, the panel module 110 may be referred to as an input element, and each of the first spring section 130 and the second spring section 140 may be referred to as an elastic connecting section, or the like. FIG. 12 is a perspective view of the electronic device according to the present embodiment. FIG. 13 is an exploded perspective view of the electronic device.

The panel module 110 includes a display such as an LCD (Liquid Crystal Display) and a touch panel for inputting information through a touch of a finger or the like. With respect to the display, light is emitted from a rear of an LCD panel, by a backlight, and thus an image can be visibly displayed. The touch panel is formed of a material that transmits light, and is disposed on a display face of the display. When the touch panel is touched with a finger or the like, the touch panel can detect a coordinate position where the finger or the like touches the touch panel, so as to input information.

The casing 120 has an opening 121 in which the panel module 110 is disposed. The support base 150 includes a base section 151 and a support section 152 for supporting the casing 120 on an inner side of the casing.

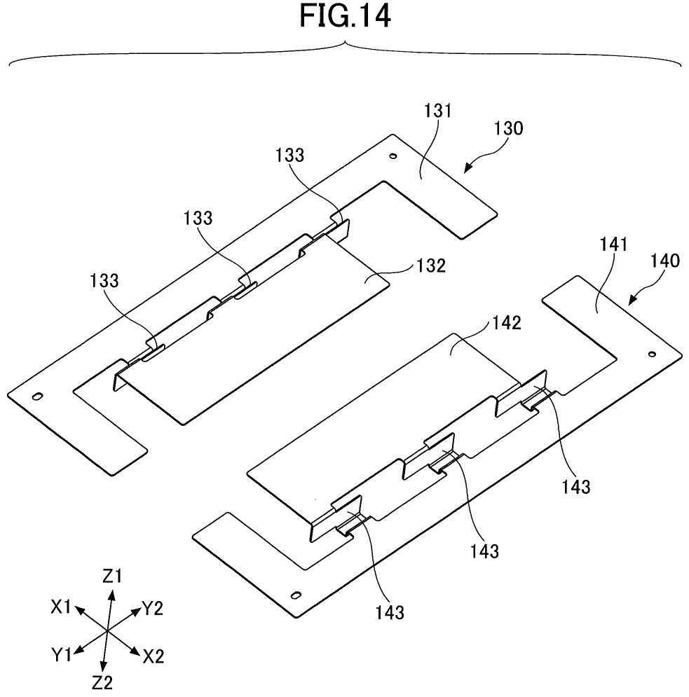

Hereafter, the first spring section 130 and the second spring section 140 will be described with reference to FIGS. 14 and 15. FIG. 14 is a perspective view of the first spring section 130 and the second spring section 140. FIG. 15 is a side view of the first spring section 130 and the second spring section 140, when viewed from an Y1 direction side. Each of the first spring section 130 and the second spring section 140 is formed by punching and bending an elastic metal plate, which is formed of stainless steel or the like.

The first spring section 130 includes an outer frame plate 131, an inner plate 132, and spring connecting sections 133 for connecting the outer frame plate 131 and the inner plate 132. Each of the outer frame plate 131 and the inner plate 132 is flat along a plane parallel to an XY plane. Three spring connecting sections 133 are provided along a Y1-Y2 direction, between the outer frame plate 131 and the inner plate 132.

Each spring connecting section 133 includes a first bent section 133a, a first flat plate section 133b, a second bent section 133c, a second flat plate section 133d, a third bent section 133e, a third flat plate section 133f, and a fourth bent section 133g, which are formed in this order in a direction from the outer frame plate 131 to the inner plate 132.

The first flat plate section 133b is formed by bending the first bent section 133a at an approximately right angle in a Z2 direction with respect to the outer frame plate 131. The second flat plate section 133d is formed by bending the second bent section 133c at an approximately right angle in the X2 direction with respect to the first flat plate section 133b. The third flat plate section 133f is formed by bending the third bent section 133e at an approximately right angle in a Z1 direction with respect to the second flat plate section 133d. The inner plate 132 is formed by bending the fourth bent section 133g at an approximately right angle in the X2 direction with respect to the third flat plate section 133f.

Note that in the present embodiment, each of the first bent section 133a, the second bent section 133c, the third bent section 133e, and the fourth bent section 133g is disposed along a Y1-Y2 direction. In other words, a bending line marking where each of the first bent section 133a, the second bent section 133c, the third bent section 133e, and the fourth bent section 133g is bent is parallel to a Y1-Y2 direction. Each of the first flat plate section 133b and the third flat plate section 133f is flat along a plane parallel to a YZ plane. The second flat plate section 133d is flat along a plane parallel to an XY plane.

The second spring section 140 includes an outer frame plate 141, an inner plate 142, and spring connecting sections 143 for connecting the outer frame plate 141 and the inner plate 142. Each of the outer frame plate 141 and the inner plate 142 is flat along a plane parallel to an XY plane. Three spring connecting sections 143 are provided along a Y1-Y2 direction, between the outer frame plate 141 and the inner plate 142.

Each spring connecting section 143 includes a first bent section 143a, a first flat plate section 143b, a second bent section 143c, a second flat plate section 143d, a third bent section 143e, a third flat plate section 143f, and a fourth bent section 143g, which are formed in this order in a direction from the outer frame plate 141 to the inner plate 142.

The first flat plate section 143b is formed by bending the first bent section 143a at an approximately right angle in a Z2 direction with respect to the outer frame plate 141. The second flat plate section 143d is formed by bending the second bent section 143c at an approximately right angle in an X1 direction with respect to the first flat plate section 143b. The third flat plate section 143f is formed by bending the third bent section 143e at an approximately right angle in a Z1 direction with respect to the second flat plate section 143d. The inner plate 142 is formed by bending the fourth bent section 143g at an approximately right angle in the X1 direction with respect to the third flat plate section 143f.

Note that in the present embodiment, each of the first bent section 143a, the second bent section 143c, the third bent section 143e, and the fourth bent section 143g is disposed along a Y1-Y2 direction. In other words, a bending line marking where each of the first bent section 143a, the second bent section 143c, the third bent section 143e, and the fourth bent section 143g is bent is parallel to a Y1-Y2 direction. Each of the first flat plate section 143b and the third flat plate section 143f is flat along a plane parallel to a YZ plane. The second flat plate section 143d is flat along a plane parallel to an XY plane.

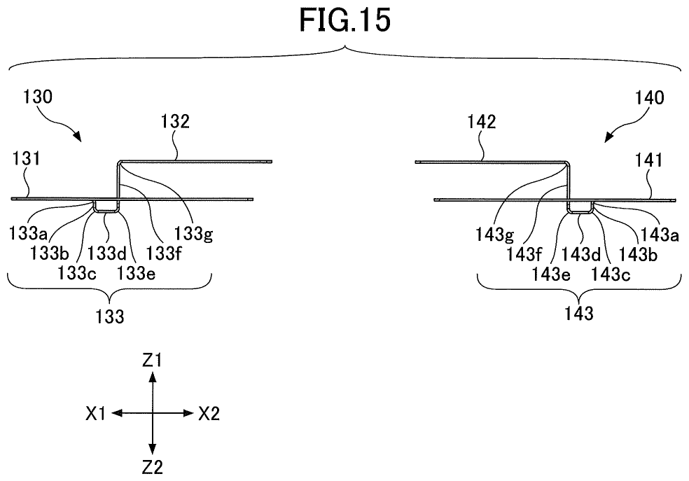

In the present embodiment, as illustrated in FIG. 16, each of the inner plate 132 of the first spring section 130 and the inner plate 142 of the second spring section 140 is connected to a lower face of the panel module 110. Each of the outer frame plate 131 of the first spring section 130 and the outer frame plate 141 of the second spring section 140 is connected on an inner side of the casing 120. Each of the inner plate 132 of the first spring section 130 and the inner plate 142 of the second spring section 140 is connected to the lower face of the panel module 110, by adhesive tape such as double-sided tape, or adhesive. Each of the outer frame plate 131 of the first spring section 130 and the outer frame plate 141 of the second spring section 140 is attached on the inner side of the casing 120, with adhesive tape such as double-sided tape, or adhesive. Alternatively, each of the outer frame plate 131 and the outer frame plate 141 is connected on the inner side of the casing 120, with screws.

Note that in the present embodiment, the vibration generating device 100, which is a vibration module, is attached to each of the inner plate 132 of the first spring section 130 and the inner plate 142 of the second spring section 140. The respective vibration generating devices 100 are attached to the inner plate 132 of the first spring section 130 and the inner plate 142 of the second spring section 140, so that a longitudinal direction of each vibration generating device 100 is a Y1-Y2 direction. In such a manner, the respective vibration generating devices 100 are attached to the inner plates 132 of the first spring section 130 and the inner plate 142 of the second spring section 140, in a manner such that each vibration generating device can vibrate in both of an X1-X2 direction and a Z1-Z2 direction. The two vibration generating devices 100 may be disposed on a lower face of the panel module 110, so as to be linearly symmetrical with respect to the Y1-Y2 direction.

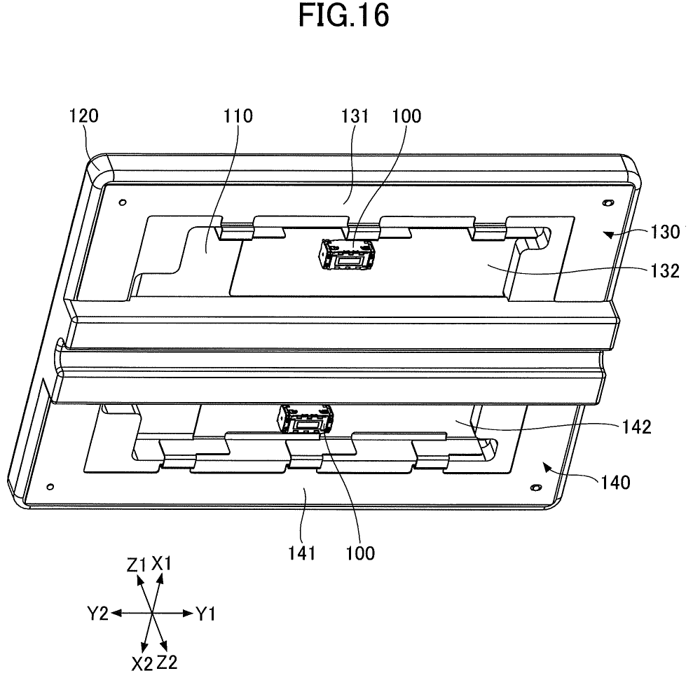

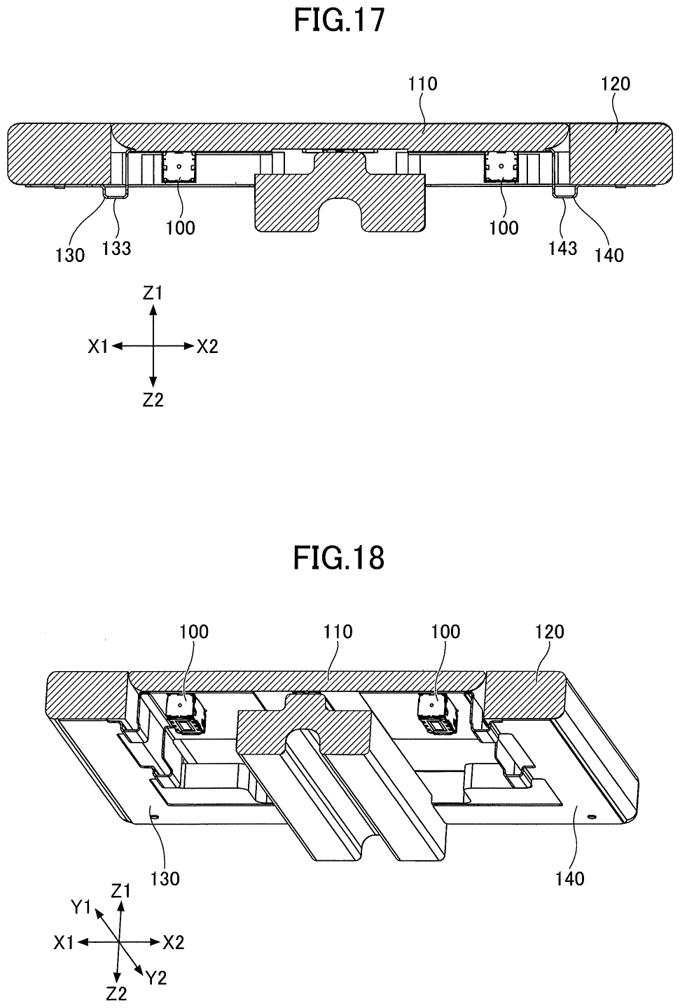

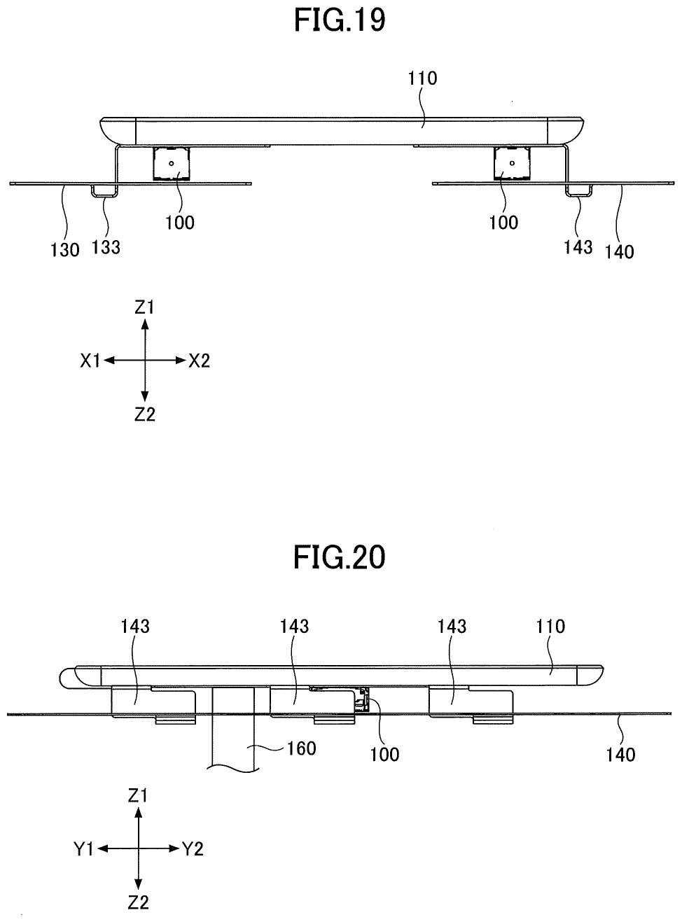

Hereafter, vibrations generated by the electronic device according to the present embodiment will be described with reference to FIGS. 17 to 20. FIG. 17 is a cross-sectional view of the electronic device taken along a ZX plane where a panel module 110, a casing 120, a first spring section 130, a second spring section 140, and vibration generating devices 100 are attached. FIG. 18 is a perspective cross-sectional view of the electronic device. FIG. 19 is a side view of the electronic device when viewed from a Y1 direction side, the electronic device including a panel module 110, a casing 120, a first spring section 130, a second spring section 140, and vibration generating devices 100. FIG. 20 is a side view of the electronic device when viewed from an X2 direction side.

In the present embodiment, each of the two vibration generating devices 100 can generate vibrations in two directions that are an X1-X2 direction and a Z1-Z2 direction, which are perpendicular to each other. A vibrational frequency at which each vibration generating device 100 vibrates in the two directions is in the range of 20 Hz or 700 Hz. A vibrational frequency at which each vibration generating device 100 vibrates in one direction is different from that in another direction.

In the present embodiment, each of the outer frame plate 131 of the first spring section 130 and the outer frame plate 141 of the second spring section 140 is connected on an inner side of the casing 120, so as to be fixed. In such a manner, the first spring section 130 and the second spring section 140 support the panel module 110 in a manner such that the panel module can be vibrated, the panel module 110 being connected to the inner plate 132 of the first spring section 130 and the inner plate 142 of the second spring section 140.

In the electronic device according to the present embodiment, when a given vibration generating device 100 generates vibrations in an X1-X2 direction, each of the first spring section 130 and the second spring section 140 is easily displaced in the X1-X2 direction, so that the panel module 110 can be vibrated in this direction. In other words, each of the spring connecting section 133 of the first spring section 130 and the spring connecting section 143 of the second spring section 140 is easily deflected in the X1-X2 direction. Thereby, when the given vibration generating device 100 generates vibrations in the X1-X2 direction, the panel module 110 can be efficiently vibrated in the X1-X2 direction.

When a given vibration generating device 100 generates vibrations in a Z1-Z2 direction, each of the first spring section 130 and the second spring section 140 is easily displaced in the Z1-Z2 direction, so that the panel module 110 can be vibrated in this direction. In other words, each of the spring connecting section 133 of the first spring section 130 and the spring connecting section 143 of the second spring section 140 is easily deflected in the Z1-Z2 direction. Thereby, when the given vibration generating device 100 generates vibrations in the Z1-Z2 direction, the panel module 110 can be efficiently vibrated in the Z1-Z2 direction.

Note that the first bent section 133a, the second bent section 133c, the third bent section 133e, and the fourth bent section 133g of the spring connecting section 133 in the first spring section 130 are formed so that bending lines of these bent sections are parallel to a Y1-Y2 direction. Also, the first bent section 143a, the second bent section 143c, the third bent section 143e, and the fourth bent section 143g of the spring connecting section 143 in the second spring section 140 are formed so that bending lines of these bent sections are parallel to the Y1-Y2 direction. In such a manner, each of the first spring section 130 and the second spring section 140 does not easily deform and deflect in a direction along such a bending line. Thereby, vibrations in the Y1-Y2 direction are not easily generated.

In the present embodiment, vibrations in an X1-X2 direction and vibrations in a Z1-Z2 direction differ in vibrational frequency. Thereby, vibrations in each direction can be transmitted to a finger or the like that touches the panel module 110, with a different tactile feeling. Further, vibrations in an X1-X2 direction and vibrations in a Z1-Z2 direction differ in vibrational direction. Accordingly, a difference between the vibrations in different directions is more pronounced through the tactile feeling. In other words, vibrations in an X1-X2 direction are generated in a direction parallel to a plane along which the panel module 110 is disposed, and vibrations in a Z1-Z2 direction are generated in a direction perpendicular to a plane along which the panel module 110 is disposed. Accordingly, a difference between the vibrations in different directions is more pronounced through the tactile feeling.

Vibrations in a Z1-Z2 direction are generated in a direction perpendicular to a plane along which the panel module 110 is disposed. In this case, when compression waves are transmitted through the ambient air due to vibrations, the vibrations may be perceived as sounds. When a frequency of vibrations is increased, displacement of the vibrations is decreased. In contrast, when a frequency of vibrations is decreased, displacement of the vibrations is increased. In terms of controlling against generating sound, a vibrational frequency of vibrations in an X1-X2 direction may be lower than that in a Z1-Z2 direction.

In the present embodiment, as illustrated in FIG. 20, a connecting interconnect 160 connected to the panel module 110 is disposed between adjacent spring connecting sections 143 of the second spring section 140. Alternatively, although not illustrated, a connecting interconnect 160 may be disposed between adjacent spring connecting sections 133 of the first spring section 130. Note that the connecting interconnect 160 is formed of a flexible substrate or the like.

In this description according to the present embodiment, a case of two spring sections being the first spring section 130 and the second spring section 140 is described. However, the first spring section 130 and the second spring section 140 may be integrated to form a single spring section. Specifically, the outer frame plate 131 of the first spring section 130 and the outer frame plate 141 of the second spring section 140 may be connected to each other, and the inner plate 132 of the first spring section 130 and the inner plate 142 of the second spring section 140 may be connected to each other. Further, the outer frame plate 131 may be connected to the outer frame plate 141, as well as the inner plate 132 being connected to the inner plate 142.

With respect to the electronic device according to the present embodiment, directions in which the vibration generating device vibrates may be two directions perpendicular to a plane along which the panel module 110 is disposed, the two directions being an X1-X2 direction and a Y1-Y2 direction.

### Second Embodiment

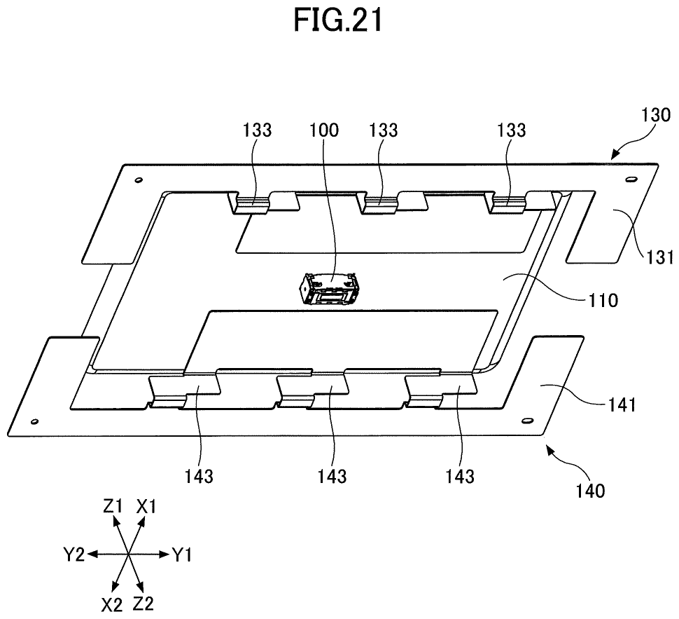

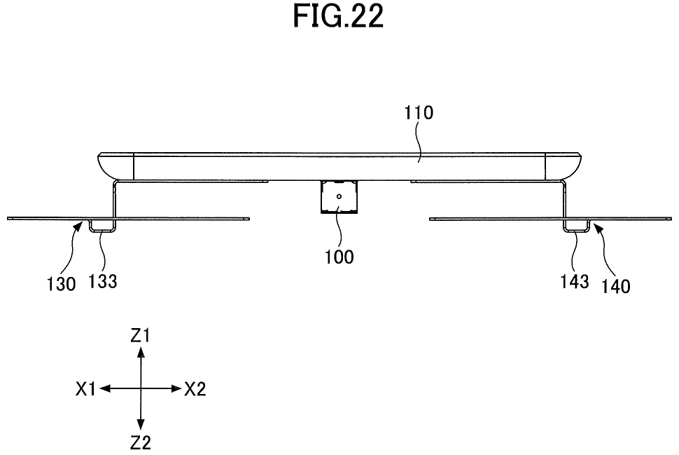

Hereafter, a second embodiment will be described. The present embodiment provides an electronic device in which one vibration generating device 100 is attached in the middle of a lower face of a panel module 110, as illustrated in FIGS. 21 and 22. FIG. 21 is a perspective view of an electronic device that includes the panel module 110, a first spring section 130 and a second spring section 140, and a vibration generating device 100, when viewed from a lower side of the vibration generating device. FIG. 22 is a side view of the electronic device. In FIGS. 21 and 22, the vibration generating device 100 is directly attached to the lower face of the panel module 110. Thereby, the panel module 110 can be vibrated directly through the vibration generating device 100, so that vibrations can be generated efficiently.

Note that a configuration of the electronic device, except for the above configuration, is same as that in the first embodiment.

The embodiments have been described in detail above, but are not limited to any particular examples described above. Various modifications and changes can be made within a scope of the present disclosure.

What is claimed is:

1. An electronic device comprising:
an input element configured to input information, the input element being responsive to a touch on a surface of the input element;
a casing having an opening in which the input element is disposed;
at least one elastic connecting section connected to the input element and the casing and configured to support the input element; and
at least one vibration generating device attached to the input element or the elastic connecting section, the vibration generating device being configured to vibrate in two directions perpendicular to each other, and
wherein the elastic connecting section is configured to be deformed in the two directions.

2. The electronic device according to claim 1, wherein the input element includes a first face, and wherein the two directions are a first direction perpendicular to the first face of the input element and a second direction parallel to the first face of the input element.

3. The electronic device according to claim 2, wherein a first frequency at which the vibration generating device vibrates in the first direction is higher than a second frequency at which the vibration generating device vibrates in the second direction.

4. The electronic device according to claim 1, wherein the at least one elastic connecting section is a plurality of elastic connecting sections.

5. The electronic device according to claim 1, wherein the elastic connecting section is formed of a metal plate, and wherein the elastic connecting section comprises:
at least one outer frame section connected to the casing;
at least one inner section connected to the input element; and
at least one spring connecting section connected to the outer frame section and the inner section, the spring connecting section including at least one bent section formed by bending the metal plate along a third direction, the third direction being perpendicular to the two directions in which the vibration generating device vibrates.

6. The electronic device according to claim 5, wherein the at least one spring connecting section is a plurality of spring connecting sections.

7. The electronic device according to claim 5, wherein the at least one vibration generating device is a plurality of vibration generating devices attached to the inner section of the elastic connecting section.

8. The electronic device according to claim 1, wherein the at least one vibration generating device is a plurality of vibration generating devices attached to the input element.

9. The electronic device according to claim 1, wherein a frequency at which the vibration generating device vibrates is in the range of from 20 Hz to 700 Hz.

10. The electronic device according to claim 1, wherein the input element includes a touch panel.
